(19) United States
(12) Patent Application Publication
(10) Pub. No.: US 2005/0110680 A1
(43) Pub. Date: May 26, 2005

(54) Microstrip antenna

(76) Inventors: Masato Tanaka, Tokyo (JP); Jae-Hyeuk Jang, Tokyo (JP)

Correspondence Address: STAAS & HALSEY LLP, SUITE 700, 1201 NEW YORK AVENUE, N.W., WASHINGTON, DC, 20005, US

(21) Appl. No.: 10/505,686

(22) PCT Filed: Feb. 25, 2003
(86) PCT No.: PCT/JP03/02017

(30) Foreign Application Priority Data
Mar. 6, 2002 (JP) 2002-060010

(51) Int. Cl. H01Q 1/38

(52) U.S. Cl. 343/700 MS

(57) ABSTRACT

A microstrip antenna has a flexible dielectric substrate (3), a flexible conductive ground plate (2) provided on a lower surface of the dielectric substrate (3), and a flexible conductive microstrip patch (4) provided on the upper surface of the dielectric substrate (3), smaller in area than the ground plate (2).

### TECHNICAL FIELD

This invention relates to a microstrip antenna, and more particularly to a microstrip antenna which is light in weight, flexible, substantially crease-free and can be attached to a wearing article such as a garment and a cap, or which will be a wearable antenna.

### BACKGROUND ART

A microstrip antenna is used as an antenna for a mobile station such as a motor vehicle, an antenna for a cellular phone, an antenna for satellite communication, and an antenna for receiving a satellite broadcast, etc.

FIG. 9 is a diagram showing an example of a conventional microstrip antenna. The conventional microstrip antenna shown in FIG. 9 has a feed circuit substrate 11, a ground plate (ground conductor) 12, an antenna substrate (dielectric) 13, a microstrip patch 14, a feed pin 15, and a feed conductor 16.

The ground plate 12 is a conductor provided between the antenna substrate 13 and the feed circuit substrate 11. The feed conductor 16 is provided on the feed circuit substrate 11 for feeding a current to the feed pin 15. A microstrip line is formed by the feed conductor 16 and the ground plate 12 and transmits electric power through it. The antenna substrate 13 is provided with the microstrip patch 14 on its upper surface. A microstrip antenna is formed by the microstrip patch 14 and the ground plate 12 and radiates radio waves. The feed pin 15 feeds electric power to the microstrip patch 14. It is a point located at an inner portion of the microstrip patch 14 that the electric power is fed from the feed pin 15. The feed conductor 16 feeds the electric power to the feed pin 15 through it.

In the above-described conventional microstrip antenna, the antenna is formed by the antenna substrate 13 and the feed circuit substrate 11, both of which are made of hard members (rigid bodies) and heavy. Further, the microstrip patch 14 and the ground plate 12 or the like are made of copper foil and are bonded to the antenna substrate 13 and the feed circuit substrate 11 by a hard adhesive. Therefore, it is difficult to attach the conventional microstrip antenna to a garment, a cap or the like.

It is an object of the present invention, in view of the above-described problem, to provide a microstrip antenna which is light in weight, flexible, substantially crease-free and can be attached to a wearing article such as a garment and a cap, or which will be a wearable antenna.

### DISCLOSURE OF INVENTION

A microstrip antenna of the present invention comprises a flexible dielectric substrate, a flexible ground plate being conductive and provided on a lower surface of said dielectric substrate, and a microstrip patch being provided on the upper surface of said dielectric substrate, smaller in area than said ground plate, flexible and conductive. According to the microstrip antenna of the present invention, a wearable antenna can be obtained which is light in weight, flexible, substantially crease-free, capable of being mounted in a non-flat place, and capable of being attached to (e.g., being sewn on) a wearing article such as a garment or a cap.

Preferably, in the microstrip antenna of the present invention, the dielectric substrate is made of a piece of cloth, and each of the ground plate and the microstrip patch is made of a piece of conductive cloth, thereby enabling the microstrip antenna to be used by being easily sewn on or embedded in a wearing article such as a garment or a cap.

Preferably, in the microstrip antenna of the present invention, the dielectric substrate is made of a piece of felt, and each of the ground plate and the microstrip patch is made of a piece of conductive cloth, thereby enabling the microstrip antenna to be easily sewn on a wearing article or otherwise attached.

### BRIEF DESCRIPTION OF DRAWINGS

FIGS. 1A and 1B are diagrams showing a microstrip antenna of the present invention, especially FIG. 1A being a cross-sectional view, FIG. 1B being a perspective view seen from an upper right position.

FIGS. 2A and 2B are diagrams showing another microstrip antenna of the present invention, especially FIG. 2A being a cross-sectional view, FIG. 2B being a perspective view seen from an upper right position.

FIG. 3 is a diagram showing a state in which the microstrip antenna in the embodiment of the present invention is worn on an arm.

FIG. 4 is a graph showing reflection characteristics in the embodiment of the present invention.

FIG. 5 is a diagram showing gain characteristics of the antenna in the embodiment of the present invention when the H-plane and the E-plane of the antenna is bent.

FIG. 6 is a graph showing radiation patterns with respect to the H-plane and the E-plane of the antenna in the embodiment of the present invention when the antenna is not bent.

FIG. 7 is a graph showing radiation patterns in the embodiment of the present invention when the E-plane of the antenna is bent through 90 degrees and through 180 degrees.

FIG. 8 is a graph showing radiation patterns in the embodiment of the present invention when the H-plane of the antenna is bent through 90 degrees and through 180 degrees.

FIG. 9 is a diagram showing a conventional microstrip antenna.

### BEST MODE FOR CARRYING OUT THE INVENTION

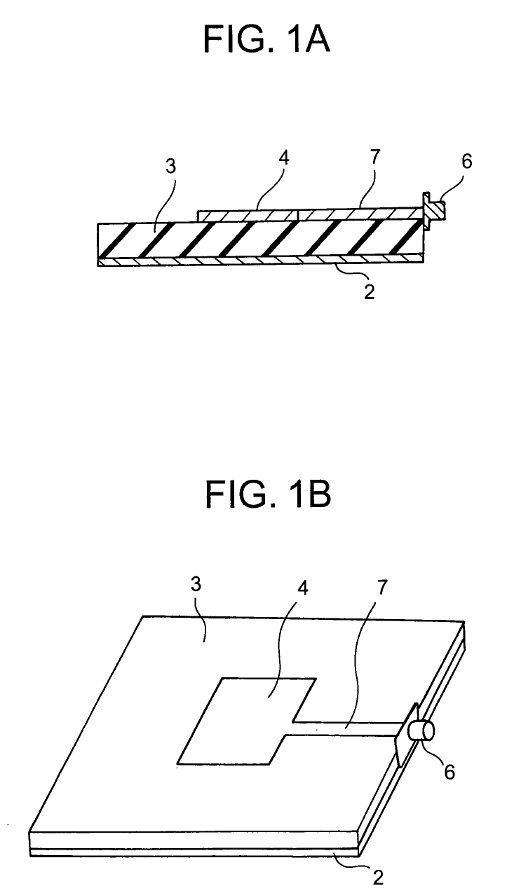

FIGS. 1A and 1B are diagrams showing a microstrip antenna of the present invention. Referring to FIG. 1, the microstrip antenna has a ground plate 2, a dielectric substrate 3, a microstrip patch 4, a connector 6 and a feed conductor (microstrip line) 7.

The microstrip antenna of the present invention has such elements as described below for solving the above-described problem.

That is, the microstrip antenna of the present invention includes the flexible dielectric substrate 3, the flexible ground plate 2 which is conductive and is provided on the lower surface of the dielectric substrate 3, and the flexible microstrip patch 4 which is conductive, is provided on the upper surface of the dielectric substrate 3 and has an area smaller than that of the ground plate 2. Further, the feed conductor 7 is also flexible and conductive. Therefore, according to the microstrip antenna of the present invention, a wearable antenna can be obtained which is light in weight, flexible, substantially crease-free, capable of being easily mounted in a non-flat place, and capable of being attached to a wearing article such as a garment or a cap.

In the microstrip antenna of the present invention, the dielectric substrate 3 is made of a piece of cloth or felt, and the ground plate 2, the microstrip patch 4 and the feed conductor 7 are made of pieces of conductive cloth. By these feature, the microstrip antenna can be easily sewn on a wearing article such as a garment or a cap or embedded therein to be used.

(1) Explanation of Structure of Antenna

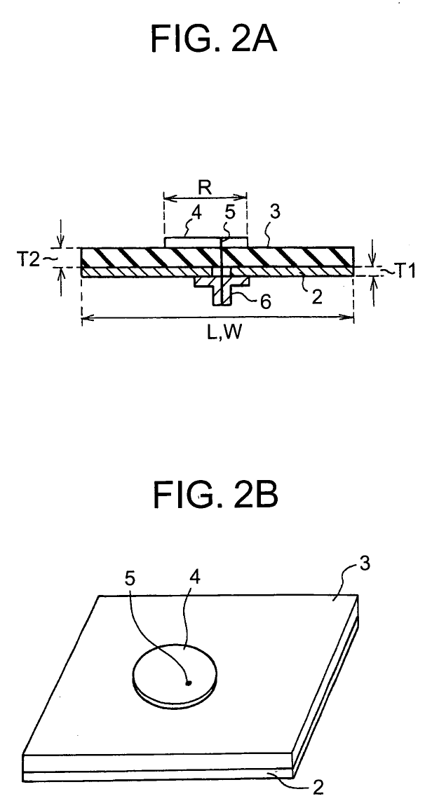

To confirm that the microstrip antenna of the present invention can perform the antenna function (radio wave radiation), an antenna was tested which has a structure shown in FIGS. 2A and 2B.

FIGS. 2A and 2B are diagrams showing another microstrip antenna, and especially FIG. 2A is a cross-sectional view of the microstrip antenna, and FIG. 2B is a perspective view seen from an upper right position. Referring to FIGS. 2A and 2B, the microstrip antenna has a ground plate (ground conductor) 2, an antenna substrate (dielectric) 3, a microstrip patch 4, a conductive pin 5, and a connector 6.

The ground plate 2 is a conductor (ground conductor) constituting a ground surface provided on a lower surface of the antenna substrate 3. The ground plate 2 is made of a piece of conductive cloth. The antenna substrate 3 is a flexible dielectric (having a dielectric constant εᵣ=1.43 in this example) such as felt or the like. The microstrip patch 4 is electrically connected to the conductive pin 5 and is made of the same conductive cloth as that of the ground plate 2. The conductive pin 5 is electrically connected to the microstrip patch 4 at a point located in an inner portion of the microstrip patch 4. The connector 6 is a connector for a fine-core coaxial cable. The microstrip antenna is designed to transmit a linearly polarized wave at a frequency of 2.5 GHz. A back-side coaxial-form feed method is used for simplification of construction. The piece of conductive cloth constituting the ground plate 2 is made of electromagnetic shielding material and has a 150×150 mm square size, a thickness (T1) of 0.15 mm, a surface density of 80 g/m², a reflection loss of 0.03 dB at 2.5 GHz and a transmission loss of 74 dB at 2.5 GHz. For example, the conductive cloth for the ground plate 2 is wove from strings which are coated with a conductive metal. The piece of felt constituting the antenna substrate 3 is made of a felt, which is commercial product, has a specific dielectric constant of 1.43, a 150 (long length)×150 (wide) mm square size and a thickness (T2) of 1 mm. The piece of conductive cloth constituting the microstrip patch 4 is made of the same material as that of the ground plate 2 and is a circle having a diameter (R) of 60 mm (see FIGS. 2A and 2B).

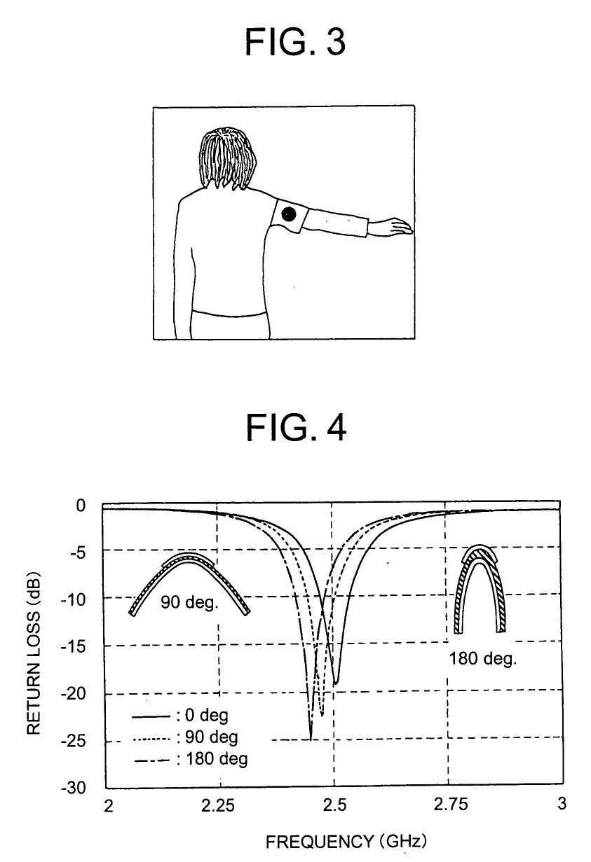

FIG. 3 shows the microstrip antenna when the microstrip antenna is worn on an arm. FIG. 3 shows a state in which the wearable microstrip antenna is wrapped around an arm. The wearable microstrip antenna uses the conductive cloth as its ground plate 2 and microstrip patch 4 (indicated as a black portion in FIG. 3), and uses the felt as its antenna substrate 3 (indicated as a white portion in FIG. 3).

(2) Explanation of Antenna Characteristics

(a) Explanation of Reflection Characteristics

FIG. 4 is a graph showing reflection characteristics. That is the reflection characteristics of the wearable microstrip antenna in a case that the antenna is bent, by assuming that the antenna is used by being sewn on a garment, a cap or the like. In FIG. 4, “0 deg.” designates a state in which the antenna is not bent, “90 deg.” designates a state in which the E-plane is bent into a V-shape at the center of the microstrip patch 4, and “180 deg.” designates a state in which the E-plane is bent into a U-shape at the center of the microstrip patch 4.

The return loss of this antenna is approximately equal to −20 dB and the resonance frequency is 2.505 GHz, in a case that the antenna is not bent. Each time the E-plane was bent by 90 degrees, the resonance frequency was shifted (reduced) by about 25 MHz. The characteristics were also measured by bending the H-plane in the same manner. It was thereby found that the frequency was shifted by about 5 MHz, and that amount of shift was smaller than that of bending of the E-plane.

“Bending of the H-plane” is bending about a line connecting a center of the microstrip patch 4 and a feed point (a connection point to the conductive pin 5). On the contrary, “bending of the E-plane” is bending about a line perpendicular to the line connecting the center of the microstrip patch 4 and the feed point.

(b) Explanation of Gain Characteristics

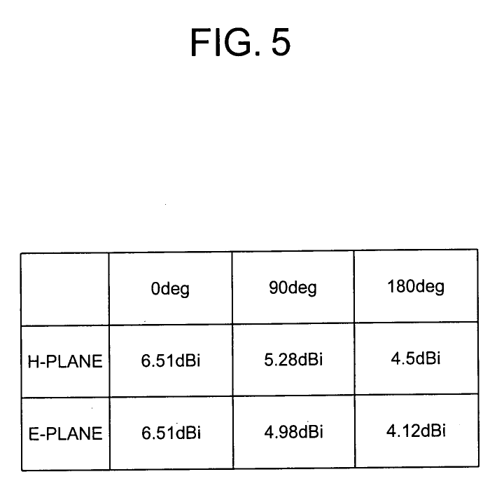

The gain is shown in FIG. 5 when the H-plane or the E-plane is bent. The frequency is 2.495 GHz at which the gain was measured under each condition. The symbol “i” in dBi denotes that the gain is relative to the gain of a nondirectional antenna.

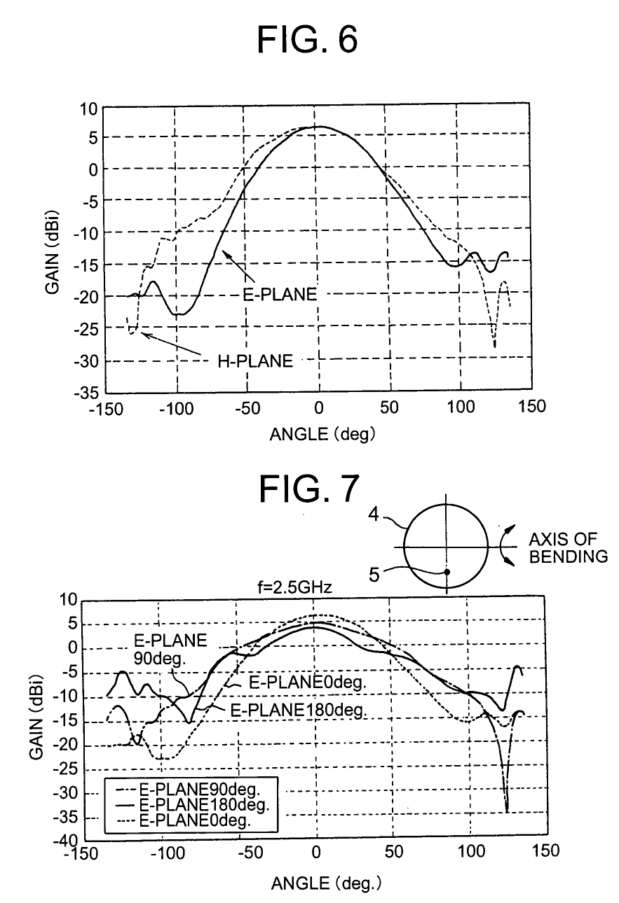

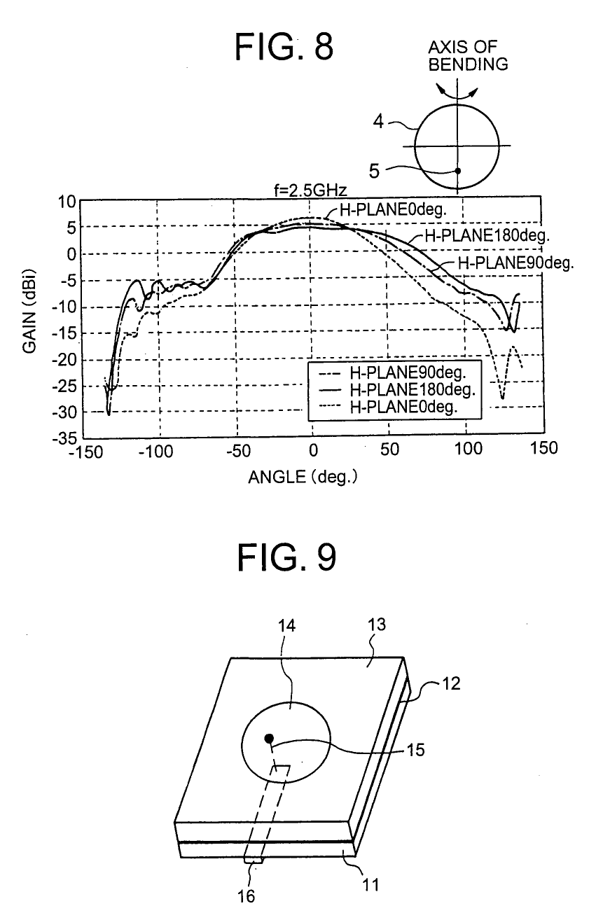

FIG. 6 is a graph showing radiation patterns with respect to the H-plane and the E-plane when the antenna is not bent. FIG. 7 is a graph showing radiation patterns with respect to the E-plane when the E-plane is bent to 90 degrees and to 180 degrees. FIG. 8 is a graph showing radiation patterns with respect to the H-plane when the H-plane is bent to 90 degrees and to 180 degrees.

From FIGS. 5 to 8, it can be understood that the gain when the E-plane is bent becomes lower than the gain when the H-plane is bent. The gain is minimized when the E-plane is bent to 180 degrees, and is reduced by 2.39 dB. From the radiation patterns shown in FIGS. 7 and 8, it can be understood that the beam width increases as the degree of bending of the microstrip antenna is increased. The reduction in gain when the microstrip antenna is bent is due to the change in resonance frequency as well as due to the increase in beam width.

From these results, it can be understood that the changing due to bending of the microstrip antenna depends on the direction in which the current flows, and the degree of degradation is determined by the density of the current distribution as seen from the position right in front.

This microstrip antenna is sufficiently effective as a microstrip antenna in actual use, since there is few probability of bending to 180 degrees is low, and since the position at which the antenna is sewn on a wearing article may be selected in a flat portion in the back or a cap, for example. Also, the antenna is sufficiently usable when a reduction in gain of about 2 dB is tolerated in a case that the antenna is bent.

The present invention has been described with respect to an embodiment thereof. Various modifications can be made in the invention in the scope of the present invention.

For example, the shape of the ground plate 2 and the antenna substrate 3 is not limited to a rectangular shape, and may be any other shape, e.g., a triangular shape, a polygonal shape having five or more sides, an elliptical shape, or a circuit shape. Also, the microstrip patch 4 may have any shape other than a circular shape, e.g., a triangular shape, a rectangular shape, a polygonal shape having five or more sides, or an elliptical shape.

The microstrip antenna can be attached to a garment, a cap or the like by being sewn on a surface with an insulating string in a patchwork manner, being bonded with an adhesive, or by being embedded therein. Also, the microstrip antenna may be attached in such a manner that a plane fastener, which is one-touch fastenable and easily separable when pulled, is provided on the lower surface of the ground plate. When the microstrip antenna made of pieces of cloth and sewn on or embedded in a garment, a cap or the like as described above, the antenna can be washed together with the garment or the cap.

The bandwidth is considerably reduced when the antenna substrate 3 is excessively small in thickness. Therefore, such material is suitable for the antenna substrate 3 as a piece of material having a thickness of about 0.1 to 3 mm, having no or only small irregularities, flat and flexible, for example, a piece of felt (nonwoven fabric), cloth (woven stuff), paper or a resin etc. By considering the directionality of the microstrip antennas, a plurality of the microstrip antennas may be attached to a cap or a garment (a kimono) (for example, three microstrip antennas may be attached to the cap in a 45-degree slanted position at 120-degree intervals).

### Industrial Applicability

As described above, the microstrip antenna of the present invention has advantages described below.

Because the microstrip antenna is constituted by a flexible dielectric substrate, a flexible ground plate which is conductive and provided on the lower surface of the dielectric substrate, and a microstrip patch which is provided on the upper surface of the dielectric substrate, smaller in area than the ground plate, flexible and conductive, the antenna can be formed as a wearable antenna which is light in weight, flexible, substantially crease-free, and can be attached to a wearing article such as a garment or a cap.

Since the dielectric substrate is a piece of cloth and the ground plate and the microstrip patch is pieces of conductive cloth, in the microstrip antenna, the antenna can be used by being easily sewn on or embedded in a wearing article such as a garment or a cap.

Further, in the microstrip antenna, since the dielectric substrate is a piece of felt and the ground plate and the microstrip patch is pieces of conductive cloth, the antenna can be easily sewn on a wearing article or otherwise attached.

1. A microstrip antenna comprising:
a flexible dielectric substrate;
a flexible ground plate being conductive and provided on a lower surface of said dielectric substrate; and
a microstrip patch being provided on the upper surface of said dielectric substrate, smaller in area than said ground plate, flexible and conductive.

2. The microstrip antenna according to claim 1, wherein said dielectric substrate is made of a piece of cloth, and each of said ground plate and said microstrip patch is made of a piece of conductive cloth.

3. The microstrip antenna according to claim 1, wherein said dielectric substrate is made of a piece of felt, and each of said ground plate and said microstrip patch is made of a piece of conductive cloth.
